(19) United States
(12) Patent Application Publication
(10) Pub. No.: US 2012/0243136 A1
(43) Pub. Date: Sep. 27, 2012

(54) SURGE PROTECTION ARRANGEMENT FOR ELECTRICAL CIRCUITS

(75) Inventors: Joseph Mossoba, Boston, MA (US); Leo Francis Casey, Lexington, MA (US); Milan Ilac, Newton, MA (US); Stephen Nichols, Boston, MA (US)

(73) Assignee: SATCON TECHNOLOGY CORPORATION, Boston, MA (US)

(21) Appl. No.: 13/070,446

(22) Filed: Mar. 23, 2011

(51) Int. Cl. H02H 9/04

(52) U.S. Cl. 361/91.1

(57) ABSTRACT

A surge protection arrangement for protecting against an overvoltage condition in an electrical circuit having a power source and an electrical load includes a reactive component (such as a capacitor or an inductor) and a switching circuit connected to the reactive component. The switching circuit causes surge energy to flow to the reactive component in response to an overvoltage condition in the electrical circuit so that the surge energy is stored in the reactive component.

### BACKGROUND OF THE INVENTION

This invention relates generally to surge protection arrangements in electrical circuits.

The electrical efficiency of switch-mode power electronics generally decreases as the voltage rating of the semiconductor devices increases, for given current ratings. Semiconductor devices, such as diodes and transistors, with increased voltage ratings also cost significantly more than lower voltage rated devices. Therefore, it is desirable to use lower voltage rated devices whenever possible. However, lower voltage rated devices are much more susceptible surges or overvoltage conditions. Simulated lightning surge tests, required by product safety certification standards, impose high voltage stresses on semiconductor-based power converters. The higher stresses tend to increase the required voltage rating of semiconductor devices, resulting in lower efficiency and higher costs.

Accordingly, there is a need for cost effective surge protection arrangements that limit surge stress on semiconductor devices, thereby permitting greater use of lower voltage rated devices and their associated efficiency/cost benefits.

### SUMMARY OF THE INVENTION

The above-mentioned need is met by the present invention, one embodiment of which provides a surge protection arrangement for protecting against an overvoltage condition in an electrical circuit having a power source and an electrical load. The surge protection arrangement includes a reactive component (such as a capacitor or an inductor) and a switching circuit connected to the reactive component. The switching circuit causes surge energy to flow to the reactive component in response to an overvoltage condition in the electrical circuit so that the surge energy is stored in the reactive component.

### DESCRIPTION OF THE DRAWINGS

FIG. 1 is a schematic view of an electrical circuit having one embodiment of a surge protection arrangement.

FIG. 2 is a schematic view of one realization of a control circuit for the surge protection arrangement of FIG. 1.

FIG. 3 is a schematic view of another realization of a control circuit for the surge protection arrangement of FIG. 1.

FIG. 4 is a schematic view of an electrical circuit having another embodiment of a surge protection arrangement.

FIG. 5 is a schematic view of an electrical circuit having yet another embodiment of a surge protection arrangement.

### DETAILED DESCRIPTION OF THE INVENTION

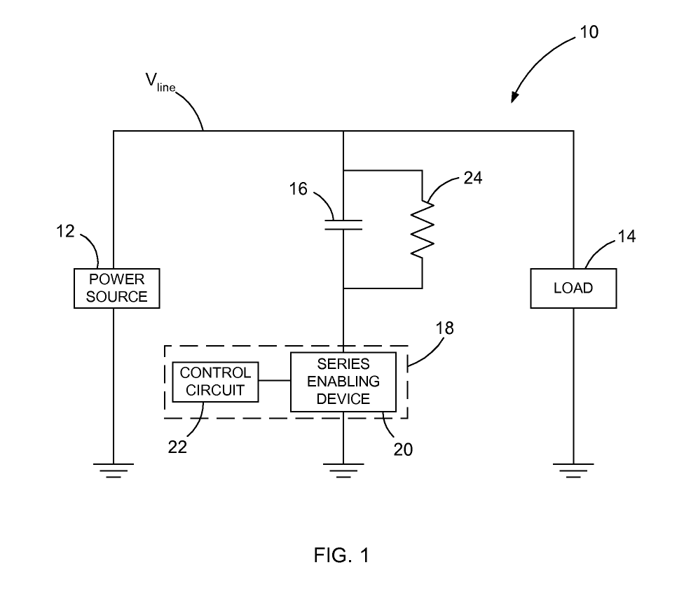

Referring to the drawings wherein identical reference numerals denote like elements throughout the various views, FIG. 1 shows an electrical circuit 10 having a power source 12 and an electrical load 14 connected across the power source 12. The electrical circuit 10 also includes one embodiment of a surge protection arrangement that protects the electrical load 14 from an overvoltage condition. The surge protection arrangement includes a reactive component 16, which is a capacitor in the illustrated embodiment, and a switching circuit 18. In response to an overvoltage condition in the electrical circuit 10, the switching circuit 18 causes surge energy to flow to the capacitor 16 so that the surge energy is stored in the capacitor 16.

The switching circuit 18 includes a series enabling device 20 and a control circuit 22 that activates the series enabling device 20 in response to an overvoltage condition in the electrical circuit 10. The series enabling device 20 is connected in series with the capacitor 16, and the capacitor 16 and the series enabling device 20 are connected in parallel with the electrical load 14.

The series enabling device 20 can be any device that is capable of being operated or controlled so as to conduct current when activated and to block current flow when not activated. Suitable series enabling devices include, but are not necessarily limited to, forward-conducting, forward-blocking devices such as IGBTs, MOSFETs and other transistors, forward-conducting, reverse- and forward-blocking devices such as thyristors, and bi-directional devices such as TRIACs and SIDACs. These types of devices are advantageous because they turn off when the current falls below their turn-off threshold.

During normal operating condition of the electrical circuit 10, the series enabling device 20 is turned off and the capacitor 16 is completely discharged. When the control circuit 22 detects a sudden increase in the magnitude of the line voltage Vₗᵢₙₑ (i.e., an overvoltage condition), the series enabling device 20 is turned on. When the series enabling device 20 is activated, current flows to the capacitor 16 so that the surge energy is stored in the capacitor 16. Once the line voltage Vₗᵢₙₑ returns to its normal operating limits, the series enabling device 20 is turned off and normal operation of the electrical circuit 10 resumes. A resistor 24 is connected in parallel across the capacitor 16 to discharge the capacitor 16 when the series enabling device 20 is turned off.

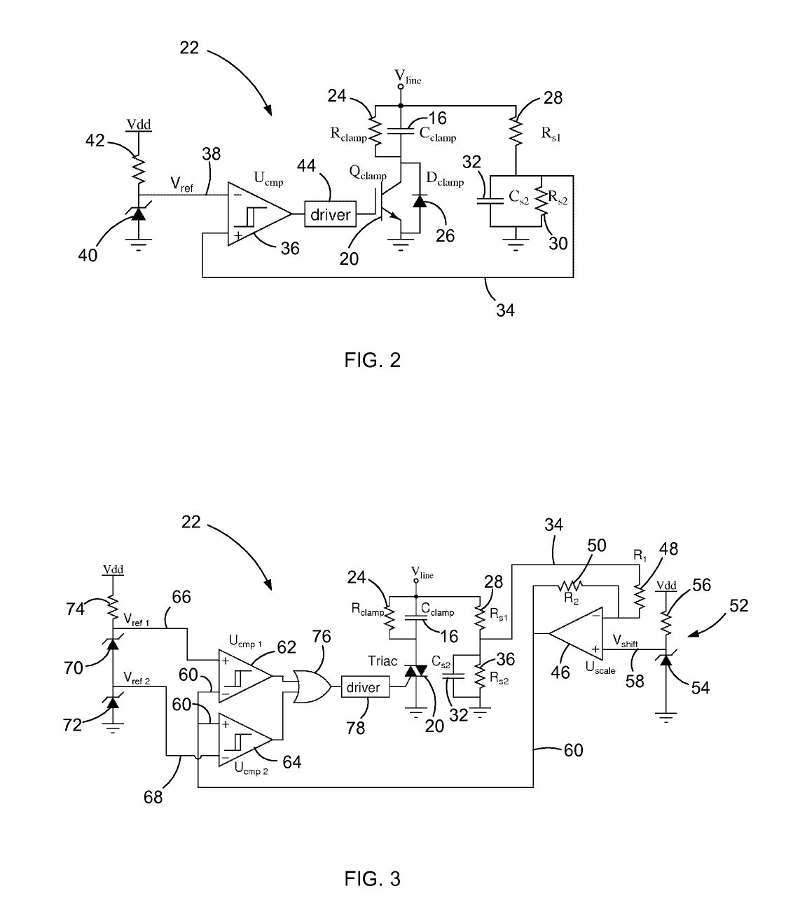

Turning to FIG. 2, one possible realization of the control circuit 22 is shown. In this case, the series enabling device 20 is an IGBT (insulated gate bipolar transistor) having its collector connected to the capacitor 16, its gate connected to the control circuit 22, and its emitter connected to ground. Because the IGBT 20 conducts in a single direction, this surge protection arrangement can also include a clamping diode 26 connected in antiparallel across the IGBT 20. In the event of a negative surge (i.e., when a transient makes the line voltage Vₗᵢₙₑ fall below zero with respect to the common reference potential (ground in the illustrated embodiment)), the clamping diode 26 conducts current so that surge energy from the transient is stored in the capacitor 16. The resistor 24 discharges the capacitor 16 when the transient ends.

The control circuit 22 includes a sensing sub-circuit that senses the line voltage Vₗᵢₙₑ and scales down the sensed line voltage Vₗᵢₙₑ to an appropriate level that can be handled and processed by the other components of the control circuit 22. The sensing sub-circuit comprises first and second resistors 28, 30 and includes a filtering capacitor 32 connected in parallel with the second resistor 30. The filtering capacitor 32 functions as a low pass filter that filters out noise. This helps prevent nuisance activations of the IGBT 20 that could otherwise be triggered by the noise.

The filtered, scaled-down signal 34 produced by the sensing sub-circuit is fed to a comparator 36. The comparator 36 compares this signal 34 to a reference signal 38. The reference signal 38 is produced by a sub-circuit comprising a Zener diode 40 and a resistor 42 connected in series to a positive supply voltage V_{DD}. When the comparator 36 determines that the scaled signal 34 exceeds the reference signal 38, the comparator 36 activates the IGBT 20 via a driver 44.

Referring to FIG. 3, another realization of the control circuit 22 is shown. In this case, the series enabling device 20 is a TRIAC, which is a bidirectional device capable of conducting current in two directions. Because the TRIAC 20 conducts in both directions, it is capable of handling both positive and negative transients and the clamping diode discussed above is not necessary in this realization.

Like the control circuit of FIG. 2, this control circuit 22 includes a sensing sub-circuit that senses the line voltage Vₗᵢₙₑ and scales down the sensed line voltage Vₗᵢₙₑ to an appropriate level that can be handled and processed by the other components of the control circuit 22. The sensing sub-circuit comprises first and second resistors 28, 30 and includes a filtering capacitor 32 connected in parallel across the second resistor 30. The filtering capacitor 32 functions as a low pass filter that filters out noise. This helps prevent nuisance activations of the TRIAC 20 that could otherwise be triggered by the noise.

The filtered, scaled-down signal 34 produced by the sensing sub-circuit is fed to an amplifier sub-circuit, which comprises an inverting amplifier 46, a pair of resistors 48, 50 and shift signal generator 52. The shift signal generator 52 comprises a Zener diode 54 and a resistor 56 connected in series to a positive supply voltage V_{DD}, and produces a shift signal 58 that is input to the amplifier 46. The filtered, scaled-down signal 34 is rescaled and shifted by the amplifier sub-circuit, and the output 60 of the amplifier sub-circuit is used by first and second comparators 62 and 64 to detect if the magnitude of the line voltage Vₗᵢₙₑ has exceeded some positive maximum or negative minimum threshold.

The first comparator 62 compares the amplifier output signal 60 to a first reference signal 66, and the second comparator 64 compares the amplifier output signal 60 to a second reference signal 68. The first and second reference signals 66, 68 are produced by a sub-circuit comprising a first Zener diode 70, a second Zener diode 72 and a resistor 74 connected in series to a positive supply voltage V_{DD}. The first comparator 62 produces an output when it determines that the amplifier output signal 60 exceeds the first reference signal 66. The second comparator 64 produces an output when it determines that the amplifier output signal 60 falls below the second reference signal 68. The outputs of the first and second comparators 62, 64 are used as a logical sum in an OR gate 76, which is connected to the TRIAC 20 via a driver 78. The TRIAC 20 is thus activated whenever the amplifier output signal 60 exceeds the first reference signal 66 or falls below the second reference signal 68.

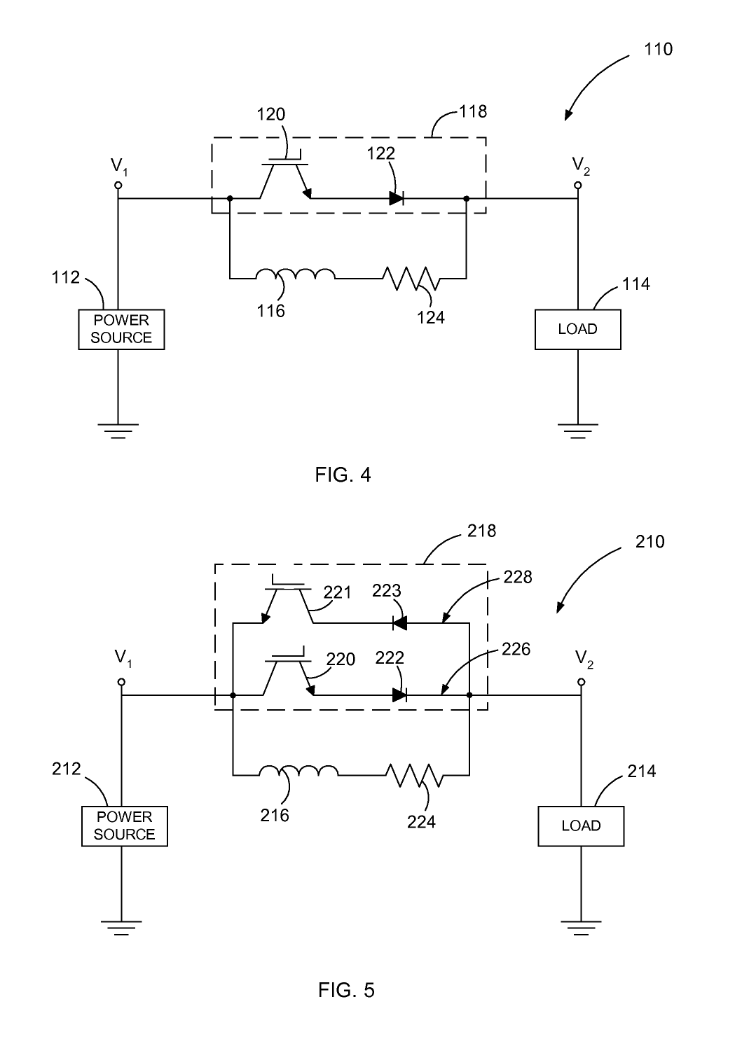

FIG. 4 shows an electrical circuit 110 having another embodiment of a surge protection arrangement. The electrical circuit 110 is a dc circuit including a dc power source 112 and an electrical load 114 connected across the power source 112. The surge protection arrangement includes a reactive component 116, which is an inductor in this embodiment, and a switching circuit 118. Current flows from the power source 112 to the electrical load 114 via the switching circuit 118 during normal operation, but the switching circuit 118 shuts off in response to an overvoltage condition causing surge energy to flow to the inductor 116 so that the surge energy is stored in the inductor 116.

The switching circuit 118 includes a transistor 120 and a diode 122 connected in series between the power source 112 and the electrical load 114. A resistor 124 is connected in series with the inductor 116, with the inductor 116 and the resistor 124 being connected between the power source 112 and the electrical load 114 and in parallel with the transistor 120 and the diode 122. In the illustrated embodiment, the transistor 120 is an IGBT having its collector connected to the power source 112 and its emitter connected to the diode 122 so as to conduct current from the power source 112 to the diode 122 when activated. The diode 122 is biased to conduct current from the transistor 120 to the electrical load 114.

During normal operating condition of the electrical circuit 110, the voltage V₁ at node 1 (adjacent the power source 112) is greater than the voltage V₂ at node 2 (adjacent the electrical load 114), and power transfer occurs from node 1 to node 2 through the transistor 120 and the diode 122. Current through the inductor 116 is maintained at or near zero by actively controlling the transistor 120. For instance, the transistor 120 can be controlled in a manner similar to how the IGBT 20 of FIG. 2 is controlled. During a positive surge at node 2 of the electrical circuit 110, the voltage V₂ suddenly increases and exceeds the voltage V₁, causing the switching circuit 118 to turn off. This effectively puts the branch comprising the inductor 116 and the resistor 124 alone between the power source 112 and the electrical load 114 (i.e., between node 1 and node 2). That is, current flows from node 2 to node 1 through the inductor-resistor branch. When this happens, the inductor 116 limits voltage increase at node 1 by storing the surge energy. When the voltage V₂ returns to its normal operating range (less than voltage V₁), the switching circuit 118 is turned on again, thus freewheeling energy stored in the inductor 116 and carrying the normal load current from node 1 to node 2.

FIG. 5 shows an electrical circuit 210 having yet another embodiment of a surge protection arrangement. The electrical circuit 210 is an ac circuit including an ac power source 212 and an electrical load 214 connected across the power source 212. The surge protection arrangement includes a reactive component 216, which is an inductor in this embodiment, and a switching circuit 218 connected between the power source 212 and the electrical load 214. Current flows between the power source 212 to the electrical load 214 via the switching circuit 218 during normal operation, but the switching circuit 218 shuts off in response to an overvoltage condition causing surge energy to flow to the inductor 216 so that the surge energy is stored in the inductor 216.

Because the electrical circuit 210 is an ac circuit, the switching circuit 218 comprises two parallel branches: a first branch 226 for conducting current from the power source 212 to the electrical load 214 and a second branch 228 for conducting current from the electrical load 214 to the power source 212. The first branch 226 includes a first transistor 220 and a first diode 222 connected in series, and the second branch 228 includes a second transistor 221 and a second diode 223 connected in series. A resistor 224 is connected in series with the inductor 216, with the inductor 216 and the resistor 224 being connected between the power source 212 and the electrical load 214 and in parallel with the first and second branches 226, 228.

In the illustrated embodiment, the first and second transistors 220, 221 are IGBTs. The first transistor 220 has its collector connected to the power source 212 and its emitter connected to the first diode 222 so as to conduct current from the power source 212 to the first diode 222 when activated. The first diode 222 is biased to conduct current from the first transistor 220 to the electrical load 214. The second diode 223 is biased to conduct current from the electrical load 214 to the second transistor 221. The second transistor 221 has its collector connected to the second diode 223 and its emitter connected to the power source 212 so as to conduct current from the second diode 223 to power source 212 when activated.

During normal operating condition of the electrical circuit 210, the first and second transistors 220, 221 are kept on so that ac current is able to flow between the power source 212 and the electrical load 214. When an overvoltage condition occurs at node 1 or node 2, both the first and second transistors 220, 221 are turned off. Current thus flows between the power source 212 and the electrical load 214 through the inductor-resister branch, allowing the inductor 216 to store the surge energy. When the electrical circuit 210 returns to its normal operation, the switching circuit 218 is turned on again, thus freewheeling energy stored in the inductor 216 while carrying normal load current between the power source 212 and the electrical load 214.

While specific embodiments of the present invention have been described, it should be noted that various modifications thereto can be made without departing from the spirit and scope of the invention as defined in the appended claims.

1. In an electrical circuit having a power source and an electrical load, a surge protection arrangement for protecting against an overvoltage condition, said surge protection arrangement comprising:
a reactive component; and
a switching circuit connected to said reactive component, wherein said switching circuit causes surge energy to flow to said reactive component in response to an overvoltage condition in said electrical circuit so that said surge energy is stored in said reactive component.

2. The surge protection arrangement of claim 1 wherein said reactive component is a capacitor and said switching circuit comprises a series enabling device connected in series with said capacitor, said capacitor and said series enabling device being connected in parallel with said electrical load, and a control circuit that activates said series enabling device in response to an overvoltage condition in said electrical circuit, wherein surge energy flows through and is stored in said capacitor when said enabling device is activated.

3. The surge protection arrangement of claim 2 further comprising a resistor connected in parallel across said capacitor.

4. The surge protection arrangement of claim 2 wherein said control circuit comprises means for sensing a line voltage in said electrical circuit and at least one comparator for comparing said sensed line voltage to a reference signal.

5. The surge protection arrangement of claim 2 wherein said series enabling device is an IGBT.

6. The surge protection arrangement of claim 5 further comprising a diode connected in antiparallel across said IGBT.

7. The surge protection arrangement of claim 2 wherein said series enabling device is a MOSFET.

8. The surge protection arrangement of claim 2 wherein said series enabling device is a thyristor.

9. The surge protection arrangement of claim 2 wherein said series enabling device is a TRIAC.

10. The surge protection arrangement of claim 2 wherein said series enabling device is a SIDAC.

11. The surge protection arrangement of claim 1 wherein:
said reactive component is an inductor connected between said power source and said electrical load;
said switching circuit comprises a transistor and a diode connected in series and is connected between said power source and said electrical load parallel to said inductor; and
current flows from said power source to said electrical load via said switching circuit during normal operation, but when an overvoltage condition occurs, said switching circuit shuts off and current flows through said inductor so that said inductor stores surge energy.

12. The surge protection arrangement of claim 11 further comprising a resistor connected in series with said inductor.

13. The surge protection arrangement of claim 1 wherein:
said reactive component is an inductor connected between said power source and said electrical load;
said switching circuit comprises a first branch connected between said power source and said electrical load parallel to said inductor, said first branch comprising a first transistor and a first diode connected in series, and a second branch connected between said power source and said electrical load parallel to said inductor, said second branch comprising a second transistor and a second diode connected in series; and
alternating current flows between said power source and said electrical load via said first and second branches during normal operation, but when an overvoltage condition occurs, said first and second branches shut off and current flows through said inductor so that said inductor stores surge energy.
